(19) United States
(12) Patent Application Publication
(10) Pub. No.: US 2014/0214636 A1
(43) Pub. Date: Jul. 31, 2014

(54) REMOTE TAX RETURN SYSTEM

(71) Applicant: IGUEHI RAJSKY, GREAT NECK, NY (US)

(72) Inventor: IGUEHI RAJSKY, GREAT NECK, NY (US)

(21) Appl. No.: 13/752,610

(22) Filed: Jan. 29, 2013

(51) Int. Cl. G06Q 40/00

(52) U.S. Cl. CPC G06Q 40/103
USPC 705/31

(57) ABSTRACT

The invention provides a business method for remote preparation of tax return services comprising of: (a) establishing a secure website offering tax return preparation services (b) registering the customer for said service via a service channel (c) collecting basic customer information including income, deduction and preference of service channel (d) classification of customer based on predetermined criteria (e) billing the customer as per customer classification (f) request for authorization and predetermined information from the customer (g) receipt of predetermined information from the customer (h) storage of customer data into the remote database (i) preparation of tax return by a first professional tax preparer (j) review by a second professional tax preparer (k) transmitting the prepared tax return to the customer for acceptance, optionally (l) filing of the prepared tax return upon receipt of customer acceptance (m) providing notification and a copy of filed return to the customer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to a business method for a tax services system, more specifically to a remote system for providing tax return services. This invention facilitates a tax payer (customer) to seek the help of a tax preparer to prepare and file tax returns from the convenience of a remote location.

2. Background of the Invention

Tax preparation and filing is a complex and iterative process which requires thorough understanding of tax laws, customer specific situation as well as time. Typically a customer has two options to meet his Internal Revenue Service (IRS) tax filing obligations; either by preparing tax returns on his own using online software or to seek the services of a professional tax preparer for completing this process.

In the first option, a customer prepares tax returns on his own with the help of commercially available software products available online or as in a standalone form such as in a CD. Although this option eliminates the need to spend time and effort in travelling to meet a tax preparer, it does not simplify the customer's experience in preparing the tax returns. Most of the times, a customer comes across uncertain tax situation, to which the online software is not able to answer satisfactorily. Though it provides inbuilt help option, most problems addressed in the help option are usually rudimentary questions, and do not thoroughly address the specific situation faced by a taxpayer. Since these software products are standardized to meet the requirements of all customers, they are provided with several features and options which may not be required for a given customer. Many software tools provide an option to have telephonic session or chat with the tax preparer to seek advice. However, the customer has to pay to buy the software or have a subscription to avail these facilities. This set up makes the process further complicated and time consuming. In addition, in order to ask a question, a taxpayer has to be first aware that there is an issue with the tax position they have taken for either reporting income or taking a deduction. In many instances, the taxpayer is not adequately aware of the tax regulation to even realize that there is a problem that requires consulting with a tax professional until they are audited, and then the search for professional help is too late. At the end, if the software is not competitive enough and if the customer does not have a thorough knowledge of tax preparation, he ends up being confused and is likely to commit mistakes in the preparation of return. There is also a likelihood of the customer missing the deadline of the tax filing in the peek time of April, thereby having to pay penalty for the delay. Besides, these software products are not user-friendly from the perspective of customers who may not be software literate, or have special needs, or are blind, disabled, or are elderly.

In the second option, customer seeks help from a professional tax preparer for tax return preparation. With regards to the option of visiting the tax preparer's office, while there is the advantage of having a one on one encounter with the tax preparer without the customer experiencing the hassle of dealing with preparing the tax return on his own, there are associated disadvantages, including but not limited to the inconvenience of traveling to the tax preparer's location, time spent in the tax preparer's waiting area, and the possibility of paying higher fees as is sometimes the case when tax preparation service providers take advantage of customers by charging per form completed even when the supporting forms are automatically generated by the tax return preparation software.

The present invention provides a solution to the above mentioned problems by overcoming the disadvantages associated with both the options. The solution offers the customer a simple, reliable and professional method for preparation of tax returns, from start to end, by engaging the services of a professional tax preparer at an affordable rate and from the comfort of a remote location, without subjecting the customer to the inconvenience of extra time or travel.

Most of the existing tax return preparation methods known in prior art rely on automated software based methods. Below are given prior art references which have been filed with respect to tax return processes but they distinctly differ from the present invention described in this patent application.

U.S. Pat. No. 7,565,312, issued on Jul. 21, 2009, titled “TAX RETURN SYSTEMS AND METHODS”, enables customers to prepare tax returns by themselves using online software tool and can avail the experts' review if required. In this invention the customer needs to complete the entire process on their own, although there is an option for review by experts, it does not provide a solution tailor made to meet individual customer needs. The process is time consuming for the customer, uneconomical and does not have a provision where the tax return is prepared by the professional tax preparer based on the specific needs of the customer.

U.S. Pat. No. 7,912,767, issued on Mar. 22, 2011, titled, “TAX PREPARATION SYSTEM FACILITATING REMOTE ASSISTANCE”, enables customers to prepare tax returns by themselves with a set up to identify if the customer is facing a problem while using the software. If the customer seeks assistance, then he is advised on how to navigate through the software interface, and optionally offered a list of tax preparers to be contacted. This makes the entire process further time consuming and leads to duplication of efforts, first when the customer attempts to use the software on his own, and on further occasions when he attempts to contact the tax preparer and explain the difficulties faced while using the software.

U.S. Pat. No. 7,860,763, issued on Dec. 28, 2010, titled, “PROACTIVE TAX PREPARATION”, is an automated system which prepares tax returns by itself without customer interface based on the previous year's customers tax return data retrieved. This solution cannot be relied upon as fully accurate since it does not involve any input from the customer's end.

U.S. Pat. No. 8,126,787, issued on Feb. 28, 2012, titled, “SYSTEM AND METHOD FOR PREPARING A TAX RETURN USING ELECTRONICALLY DISTRIBUTED TAX RETURN DATA” provides a computer system in which a tax preparer, with the consent of the customer, can retrieve tax return data from third party's database. This method is not practical at all times since it essentially relies on availability of electronic tax return data.

U.S. Pat. No. 8,204,805, issued on Jun. 19, 2012, titled “INSTANT TAX RETURN PREPARATION” describes a method involving generation of a partially completed tax return based on basic user information without needing to obtain other user inputs through an extensive user interview. This is again a computer based system and the accuracy of a partially completed tax return is doubtful if there is an oversight by the customer while reviewing the partially completed tax return.

U.S. Pat. No. 7,805,343, issued on Sep. 28, 2010, titled, “METHOD AND APPARATUS FOR MANAGING TAX RETURN PREPARATION”, provides a method for managing tax return preparation for employees of a corporate entity based on the authorization received. This method is unsuitable for preparing tax return of individual tax payers based on their specific requirements.

U.S. Pat. No. 7,747,484, issued on Jun. 29, 2010, titled, “AUTOMATED TAX RETURN WITH UNIVERSAL DATA IMPORT”, provides a fully automated software system, which can be unreliable in case the customer misses out mentioning any financial institution with which he has a relationship.

U.S. Pat. No. 7,853,494, issued on Dec. 14, 2010, titled, “EFFICIENT WORK FLOW SYSTEM AND METHOD FOR PREPARING TAX RETURNS” includes a processor-based method for preparing a tax return using multiple service providers and is hence associated with higher overhead costs and is not economical.

U.S. Pat. No. 7,756,761, issued on Jul. 13, 2010, titled, “TAX RETURN OUTSOURCING AND SYSTEMS FOR PROTECTING DATA” discloses a system for outsourcing tax return preparation services remote locations outside the United States which involves multiple interfaces between the customer and final service providers resulting in a lack of timely, responsive and personalized engagement with the customer.

The prior art references listed above make it evident that there is a strong need to have a method for preparation of tax returns which is not only economical, responsive and personalized to specific customer needs but also makes it a convenient experience for the customer saving him effort and time spent in meeting a professional tax preparer or using an automated software product.

### SUMMARY OF THE INVENTION

The present invention provides a business method for remote preparation of tax return services which offers a customer the advantage of customized tax return preparation from the convenience of home or any remote location at an economical rate and without loss of time, effort or responsiveness. A remote tax return preparation method in accordance with present invention comprises of:
(a) establishing a secure website offering tax return preparation services to a remote customer
(b) registering the customer for said service via a service channel such as the internet, telephone, email, mail
(c) collecting basic customer information including income, deduction and preference of service channel from the customer
(d) classification of customer based on predetermined criteria according to the basic customer information collected
(e) billing the customer for registered service as per service level corresponding to customer classification
(f) request for authorization and predetermined information from the customer based on the customer classification done in step (d) via the preferred service channel
(g) receipt of predetermined information from the customer via the preferred service channel
(h) storage and updation of customer data into the remote database
(i) preparation of tax return by a first professional tax preparer by accessing information from the remote database and storage of prepared tax return in remote database
(j) review and modification of prepared tax return by a second professional tax preparer by accessing prepared tax return stored in remote database
(k) transmitting the prepared tax return to the customer for acceptance via the preferred service channel
(l) electronic filing of the prepared tax return upon receipt of customer acceptance via the preferred service channel
(m) providing notification and a copy of filed return to the customer via the preferred service channel.

The primary object of the present invention is to provide a reliable and professional tax return preparation service for use by a remotely located customer without having the customer use a tax return preparation software product and without having the customer personally visit the office of a professional tax preparer.

Another object of the present invention is to continue to offer tax return preparation services to the customer even if he has moved to a new state.

A further object of the present invention is to offer a tax return preparation service which is easy to use, economical and responsive to the customer.

A still further object of the present invention is to offer a tax return preparation service which is reliable, accurate, prompt and tailor made to the customer's individual needs.

Yet another object of the present invention is to provide the option to the customer to interact, communicate and transmit the basic and predetermined information required for the purpose of tax return preparation via a preferred service channel such as the website, email, telephone or postal mail, either singly or in combination.

Another object of the present invention is to provide a tax return preparation service that provides tax return preparation services from the time information is received to when it is transmitted, including providing service and assistance to queries from the IRS.

The present invention aims to maintain a professional yet personal and responsive customer—tax preparer relationship, which is of importance for customers, who are not able to easily comprehend available tax return preparation software tools, and who cannot afford the cost, travel time and additional effort associated with visiting the office of a professional tax preparer. Such customers may include people with special needs, disabled, blind or the elderly.

These and other objects of the present invention are further elaborated in the detailed description of the invention. These objects should be construed to be merely illustrative of some of the more prominent features and applications of the invention and not as to limit the scope of the invention. Applying or modifying the disclosed invention in a different manner can attain many other beneficial results or modifying the invention as will be described. Accordingly, referring to the following drawings may have a complete understanding of the invention. Description of the preferred embodiment is as follows.

### BRIEF DESCRIPTION OF THE DRAWING

For a better understanding of the present invention and its various embodiments, reference is made to the following detailed description to be read in conjunction with the accompanying drawings, wherein:

FIG. 1 is a diagrammatic representation of a business method for providing tax return preparation services in accordance with the present invention.

FIG. 2 is a flow diagram explaining the process steps in an aspect of the present invention.

### DETAILED DESCRIPTION OF THE INVENTION

The present invention is now described with reference to the drawings.

In general, the present invention provides a method for preparation of tax returns of a customer remotely by using the services of one or more professional tax return preparer.

The present invention provides a business method for remote preparation of tax return services which offers a customer the advantage of customized tax return preparation from the convenience of home or any remote location at an economical rate and without loss of time, effort or responsiveness. A remote tax return preparation method in accordance with present invention comprises of:
(a) establishing a secure website offering tax return preparation services to a remote customer
(b) registering the customer for said service via a service channel such as the internet, telephone, email, mail
(c) collecting basic customer information including income, deduction and preference of service channel from the customer
(d) classification of customer based on predetermined criteria according to the basic customer information collected
(e) billing the customer for registered service as per service level corresponding to customer classification
(f) request for authorization and predetermined information from the customer based on the customer classification done in step (d) via the preferred service channel
(g) receipt of predetermined information from the customer via the preferred service channel
(h) storage and updation of customer data into the remote database
(i) preparation of tax return by a first professional tax preparer by accessing information from the remote database and storage of prepared tax return in remote database
(j) review and modification of prepared tax return by a second professional tax preparer by accessing prepared tax return stored in remote database
(k) transmitting the prepared tax return to the customer for acceptance via the preferred service channel
(l) electronic filing of the prepared tax return upon receipt of customer acceptance via the preferred service channel
(m) providing notification and a copy of filed return to the customer via the preferred service channel.

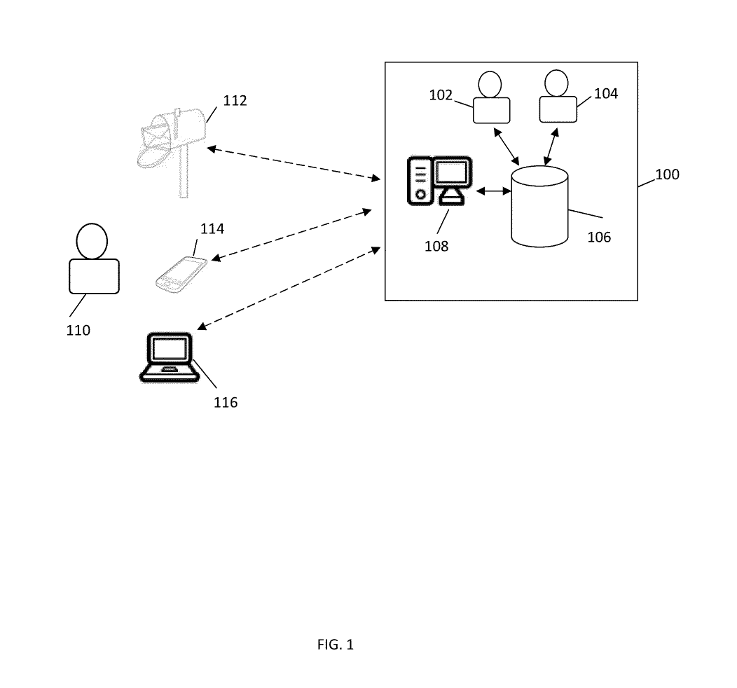

FIG. 1 depicts a system 100 that depicts the main elements of a remote tax preparation method in accordance with one or more embodiments of the invention. In one or more embodiments of the invention, one or more elements as shown in FIG. 1 may be omitted, repeated, and/or substituted. As shown in FIG. 1, 110 denotes a remote customer located at a different geographical location from a first tax preparer 102 and a second tax preparer 104. The customer 110 may use one or more of a service channel in combination or at different points in time to interact with the remote tax return preparation system 100. For illustrative purposes, the service channels that may be used by the customer 110 may include the postal mail service 112, a mobile phone device 114 with internet connectivity, a computer 116 with internet connectivity. Other examples of service channels may include a courier service, postal mail box, fax, scanning and uploading directly on website, transmitting through email. Any of the service channels may be used by the remote customer to transmit specific customer related data that is required by the remote tax return preparation system 100. The system 100 includes a computer system having a secure website hosted on a server 108, a remote database 106, a first tax return preparer 102 and a second tax return preparer 104.

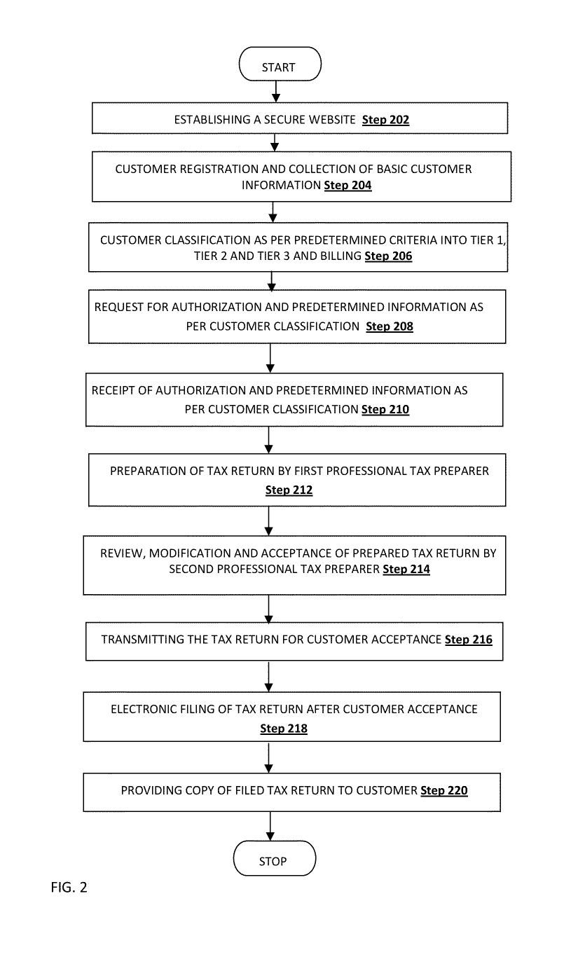

FIG. 2 depicts a flowchart of a method in accordance with one or more embodiments of the present invention. In one or more embodiments of the present invention, one or more of the steps shown in FIG. 2 may be omitted, repeated or performed in a different order. Accordingly, embodiments of the present invention should not be considered limited to the specific arrangement of steps as depicted in FIG. 2.

In step 202, a secure website is hosted on a server. In step 204, a remote customer registers for availing the service of tax return preparation. At this stage, the customer signs up for the service and agrees to the terms of usage of the website and provides basic customer related information. This information may be directly uploaded on the website or may be transmitted by means such as email, fax, scanning and transmitting via email, postal or courier service.

In step 206, customer classification is done into the categories Tier 1, Tier 2 and Tier 3 based on pre-determined criteria. These pre-determined criteria are based on income and deduction section for customers. A Tier 1 customer classification is used for basic customers taking standard deduction, such as taxpayers who have basic tax returns, are eligible to file short forms, do not have investment, are taking the standard deduction, and do not have any unusual tax situations. A Tier 2 customer classification is used for customers taking itemized deduction such as taxpayers who have basic investment activities, and/or mortgages. A Tier 3 customer classification is for customers with businesses, investments and farm income, such as those who do not fall into Tier 1 or Tier 2 categories.

Billing will be based on the customer classification that denotes the taxpayer's tax position, which has been broadly divided into the three tiers as indicated. A customer will be asked a series of preliminary questions while registering for the service on the website by a program and the answers will determine which tier the customer may be classified into. The program will also suggest the selected tier to the customer which the customer has the option to either accept or decline. The customer will also have the option to switch tiers before submitting specific information for tax preparation.

Once the customer classification into appropriate tier is done, a flat rate billing based on the service level corresponding to given customer tier is presented to the customer. The customer is thus aware of the payment he needs to make for registering for the service right up front. In a preferred embodiment of the present invention, the customer needs to pay for the service in advance but has the option of cancelling the service within a pre-determined time limit.

In step 208, there is a request for authorization and predetermined information as per customer classification done in step 206. This is to ensure that a customer does not have to provide any redundant information which is not applicable in his case. This request may be transmitted via the service channel preferred by the customer.

In step 210, there is receipt of the requested authorization and predetermined information from the customer via the preferred service channel into the remote database.

In step 212, the first tax preparer prepares the tax returns using the information stored in the remote database.

In step 214, the tax return prepared by the first tax preparer and stored in the remote database is accessed and reviewed by the second tax preparer. Based on the feedback of the second tax preparer, changes or modifications in the prepared tax return if any, are made by the first tax return preparer, and/or the second tax return preparer till the review of the prepared tax returns is completed and finalized.

In step 216, the prepared and reviewed tax returns are transmitted to the customer via preferred service channel for customer review and acceptance. In an embodiment of the invention, the customer review and acceptance step is optional or may be totally absent.

In step 218, the tax returns accepted by the customer are filed electronically. In an alternate embodiment, the tax returns may be filed by the tax preparer by paper.

In step 220, a copy of the filed tax returns is provided to the customer via preferred service channel.

In case there are any issues with the tax return owing to customer's fault including, but not limited to, false representation, misrepresentation, omitted information, then an amended tax return may be filed at the customer's request at an additional cost.

In an embodiment of the invention, the customer may change the preferred service channel at any time.

In an embodiment of the invention, the customer may use one or more of the service channels in any combination. Examples of service channels include postal mail, courier service, fax, scan and upload data on website or transmit via email using computer, laptop device, PDA or a smart phone. If a customer has any queries he has the option of contacting the customer care representative of the remote tax preparation service provider via means such as email, phone, logging on website, online chat or video conferencing. The customer has the option of updating choice of the preferred service channel as per his convenience at any time after registering for the service.

In an embodiment of the present invention, the remote tax preparation service provider may have a liaison arrangement with one or more postal services stores that also operate an office for printing and scanning. The store will have a drop box dedicated specifically for use by registered customers to drop their documents for tax return preparation.

In an embodiment of the present invention, there is only one tax preparer who prepares as well as reviews the prepared tax returns.

In an embodiment of the present invention, there is a team of multiple tax preparers and tax reviewers selected and assigned as per the tier into which the customer is classified into.

While the invention has been described with reference to above embodiments, additional modifications can be made without departing from the spirit and scope of the invention as a whole.

1. A method for remote preparation of tax return services comprising of
(a) establishing a secure website offering tax return preparation services to a remote customer,
(b) registering the customer for said service via a service channel,
(c) collecting basic customer information including income, deduction and preferred service channel from the customer,
(d) classification of customer based on predetermined criteria into tiers according to the basic customer information collected,
(e) billing the customer in advance for registered service as per service level associated with customer classification tier,
(f) request for authorization and predetermined information from the customer based on the customer classification done in step (d) via the preferred service channel,
(g) receipt of predetermined information from the customer via the preferred service channel
(h) storage and updation of customer data into the remote database
(i) preparation of tax return by a first professional tax preparer by accessing information from the remote database and storage of prepared tax return in remote database
(j) review and modification of prepared tax return by a second professional tax preparer by accessing prepared tax return stored in remote database
(k) transmitting the prepared tax return to the customer for acceptance via the preferred service channel
(l) electronic filing of the prepared tax return upon receipt of customer acceptance via the preferred service channel
(m) providing notification and a copy of filed return to the customer via the preferred service channel.

2. A method according to claim 1 wherein step (j) pertaining to acceptance of prepared tax return by customer is absent.

3. A method according to claim 1 wherein preparation and review of tax return is done by a single professional tax preparer.

4. A method according to claim 1 wherein preparation and review of tax returns is done by multiple professional tax preparers according to the customer classification tier.

5. A method according to claim 1 wherein the preferred service channel is selected from a group of virtual means comprising of direct uploading on website, scanning and transmitting via email, scanning and transmitting via fax, mailing by postal service, transmitting by courier service, transmitting through postal service stores having a dedicated drop box facility for registered customers.

6. A method according to claim 1 wherein customer classification in step (d) involves categorization of customer into three tiers, wherein Tier 1 comprises of customers taking standard deduction, Tier 2 comprises of customers taking itemized deduction and Tier 3 comprises of customers with businesses, investments and farm income.

7. A method according to claim 1, wherein the tax preparer paper files the tax returns in step (1).

8. A method according to claim 1, wherein the customer can use a combination of multiple service channels to interact with the remote tax preparing service provider.

9. A method according to claim 1, wherein the customer can change the preferred service channel at any time after registration.

10. A method according to claim 1, wherein amended tax returns can be prepared and submitted.

11. A method according to claim 1, wherein the customer is presented with information regarding billing associated with each tier at the time of registration for the service.

12. A method according to claim 1, wherein the customer is presented with an option of cancelling the registered service within a predetermined time limit.
